(19) United States
(12) Patent Application Publication
(10) Pub. No.: US 2013/0259319 A1
(43) Pub. Date: Oct. 3, 2013

(54) IMAGE SCAN METHOD, SYSTEM AND COMPUTER READABLE MEDIUM

(71) Applicants: Murthy Vinjamuri, Sunnyvale, CA (US); Yasunori Ikeno, Tokyo (JP)

(72) Inventors: Murthy Vinjamuri, Sunnyvale, CA (US); Yasunori Ikeno, Tokyo (JP)

(73) Assignee: Olympus Corporation, Tokyo (JP)

(21) Appl. No.: 13/596,476

(22) Filed: Aug. 28, 2012

Related U.S. Application Data
(60) Provisional application No. 61/617,499, filed on Mar. 29, 2012.

(51) Int. Cl. G06K 9/00

(52) U.S. Cl. 382/109

(57) ABSTRACT

An image scan is performed by obtaining a protocol identifier, determining scan conditions from the protocol identifier, and generating an image of a specimen according to the scan conditions. An image scan system has a computer to determine scan conditions from a protocol assigned to a specimen, and a scan assembly to conduct an image scan of the specimen according the scan conditions. A computer readable medium has instructions to obtain a protocol identifier, instructions to determine scan conditions from the protocol identifier, and instructions to generate an image of a specimen according to the scan conditions.

### CROSS-REFERENCE TO RELATED APPLICATIONS

This application claims the benefit of U.S. Provisional Application No. 61/617,499, filed Mar. 29, 2012, which is incorporated herein by reference.

### FIELD OF THE INVENTION

This invention relates generally to image scanning, more particularly, to automation of image scanning.

### BACKGROUND

Image scanning of specimens, such as biological and industrial items, often requires the application of specific scan conditions, such as magnification factor, in order to produce a suitable image for showing a particular attribute of the specimen. Often there are many scan conditions that must be applied in combination to obtain a suitable image, which can make setup and preparations for scanning tedious and time consuming. Even in cases where scan conditions are few in number, batch processing of multiple specimens can be tedious and time consuming when each specimen requires different scan conditions. Also, the use of an incorrect scan condition can lead to inaccuracy in detecting or assessing an attribute of the specimen, and may require that the specimen be scanned again which increases cost and reduces efficiency. Accordingly, there is a need for a rapid, easy to use, and reliable method and system for applying scan conditions for an image scan.

### SUMMARY OF THE INVENTION

Briefly and in general terms, the present invention is directed to an image scan method and system, and to a non-transitory computer readable medium.

In aspects of the present invention, an image scan method comprises obtaining a protocol identifier, followed by determining a plurality of scan conditions from the protocol identifier, the determining performed by a computer, and followed by generating an image of a specimen according to the plurality of scan conditions.

In other aspects, the obtaining of the protocol identifier includes the computer determining the protocol identifier from user interaction with a user interface in communication with the computer.

In other aspects, the obtaining of the protocol identifier includes the computer inferring the protocol identifier from a specimen property of the specimen.

In other aspects, the obtaining of the protocol identifier further includes the computer obtaining the specimen property from user interaction with a user interface before inferring the protocol identifier from the specimen property.

In other aspects, the obtaining of the protocol identifier includes obtaining the protocol identifier from a machine readable code of a code label attached to the specimen, a carrier supporting the specimen, or a cassette containing the specimen.

In other aspects, the obtaining of the protocol identifier includes the computer inferring the protocol identifier from a specimen property indicated in a machine readable code of a code label attached to the specimen, a carrier supporting the specimen, or a cassette containing the specimen.

In other aspects, the obtaining of the protocol identifier further includes the computer obtaining the specimen property from a code reader device before inferring the protocol identifier from the specimen property.

In other aspects, the obtaining of the protocol identifier includes the computer obtaining the protocol identifier from a CSV file.

In other aspects, the obtaining of the protocol identifier further includes, before obtaining the protocol identifier from the CSV file, the computer receiving any one or both of a CSV file name and a CSV file path from a machine-readable code of a code label or from user interaction with a user interface.

In other aspects, the obtaining of the protocol identifier includes the computer inferring the protocol identifier from a specimen property indicated in a CSV file.

In other aspects, the obtaining of the protocol identifier further includes, before inferring the protocol identifier from the specimen property, the computer obtaining any one or both of a CSV file name and a CSV file path from a machine-readable code of a code label or from user interaction with a user interface.

In aspects of the present invention, an image scan system comprises a computer configured to determine a plurality of scan conditions from a protocol assigned to a specimen, and a scan assembly in communication with the computer and configured to conduct an image scan of the specimen according the scan conditions determined by the computer.

In other aspects, the system further comprises a user interface in communication with the computer and configured to receive user input that identifies the protocol and assigns the protocol to the specimen, wherein the protocol is one in a plurality of protocols stored in the computer.

In other aspects, the system further comprises a user interface in communication with the computer and configured to receive user input that indicates a specimen property of the specimen, wherein the computer is configured to infer the protocol from the specimen property.

In other aspects, the system further comprises a code reader device in communication with the computer and configured to obtain an identifier of the protocol from a machine-readable code.

In other aspects, the system further comprises a code reader device in communication with the computer and configured to obtain, from a machine-readable code, a specimen property of the specimen, wherein the computer is configured to infer the protocol from the specimen property.

In other aspects, the computer is configured to parse a record of a CSV file and to determine from the record an identifier of the protocol.

In other aspects, the computer is configured to parse a record of a CSV file, determine from the record a specimen property of the specimen, and then infer the protocol from the specimen property.

In aspects of the present invention, a non-transitory computer readable medium has a stored computer program embodying instructions, which when executed by a computer, causes the computer to drive a scan assembly. The computer readable medium comprises instructions to obtain a protocol identifier, instructions to determine a plurality of scan conditions from the protocol identifier, and instructions to generate an image of a specimen according to the plurality of scan conditions.

In aspects of the present invention, the non-transitory computer readable medium further comprises instructions for determining the protocol identifier from any one or a combination of a machine readable code of a code label, user interaction with a user interface in communication with the computer, and a CSV file.

In aspects of the present invention, the non-transitory computer readable medium further comprises instructions for obtaining a specimen property of the specimen from any one or a combination of a machine readable code of a code label, user interaction with a user interface in communication with the computer, and a CSV file, and instructions for inferring the protocol identifier from a specimen property of the specimen.

The features and advantages of the invention will be more readily understood from the following detailed description which should be read in conjunction with the accompanying drawings.

### BRIEF DESCRIPTION OF THE DRAWINGS

FIG. 1 is a block diagram showing a scan system.

FIG. 2 is a perspective view showing a specimen on a specimen carrier.

FIG. 3 is a perspective view of a cassette containing multiple specimen carriers.

FIG. 4 is a block diagram showing process pathways to assigning a protocol for use in scanning a specimen or group of specimens.

### DETAILED DESCRIPTION OF EXEMPLARY EMBODIMENTS

As used herein, a “specimen” can be any item or thing capable of being the subject of an image scan to produce an image of the specimen. Specimens include, without limitation: biological samples, for example plant and animal tissues; material samples, for example synthetic and naturally-occurring compositions, minerals, and textiles; and industrial components, for example electronic and mechanical parts. Other types of specimens are possible.

As used herein, an “image” can be a computer readable digital image file, photograph, print, transparent slide, film negative, or other format.

As used herein, a “scan condition” is a parameter or variable used by a scan system to customize or adjust the manner in which a scan system generates an image of a specimen. Some scan conditions can affect the appearance of the image, such as the color, brightness, sharpness, and/or contrast of the image. Types of scan conditions include, without limitation, magnification factor and/or method, focusing method, exposure mode, shutter speed, resolution or image quality, image storage location, and security option. A security option can limit access to the image. The value associated with a particular scan condition can be a number within a predetermined range, for example a brightness value within the range of 0 to 100; a state, for example a resolution state of 1 for low, 2 for intermediate, and 3 for high; and an alphanumeric record, for example a file name and path to the image storage location when the image is in the form of a computer readable digital image file. Other values for scan conditions are possible.

As used herein, a “protocol” corresponds to one or more scan conditions. A protocol allows a set of scan conditions to be applied to an image scan process for one or more specimens without having to specify individual scan conditions.

As used herein, a “CSV file” is computer readable file containing a plurality of records separated by commas or other predetermined character or combination of characters. For example and not limitation, a CSV file can contain tabular data (numbers and/or text) in plain-text form. A CSV file may contain a record having an explicit protocol identifier or a record having information from which a protocol can be inferred. A CSV file allows for image scan processing of a multitude of different types of specimens without having to specify a protocol or other information between image scans.

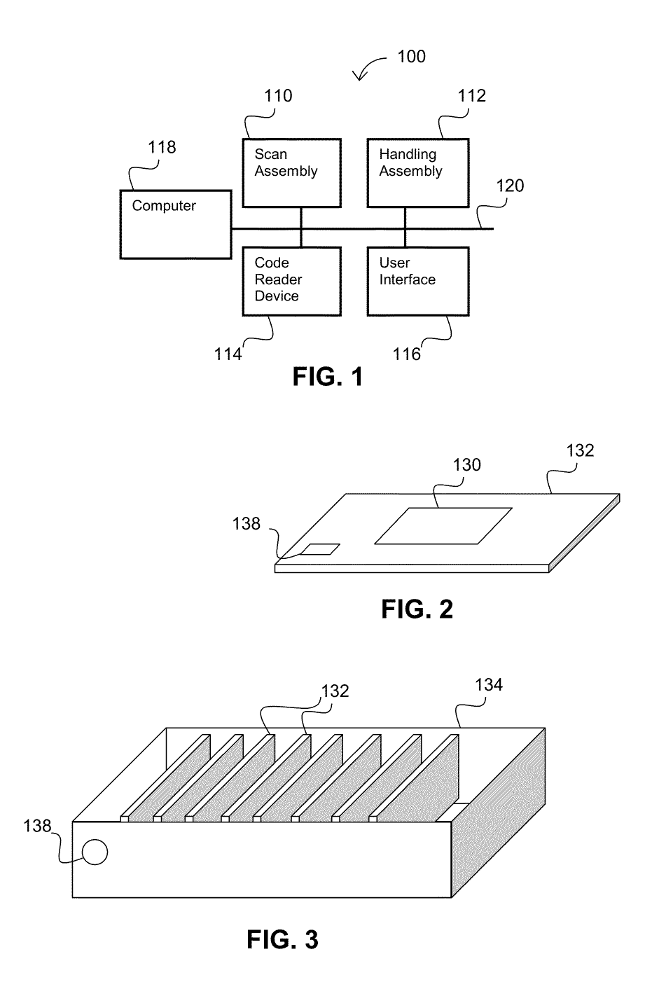

Referring now in more detail to the exemplary drawings for purposes of illustrating non-limiting embodiments of the invention, wherein like reference numerals designate corresponding or like elements among the several views, there is shown in FIG. 1 scan system 100 including scan assembly 110 and computer 118.

In various embodiments, scan system 100 further includes one or any combination of handling assembly 112, code reader device 114, and user interface 116. Computer 118 is in two-way communication, via bus 120, with scan assembly 110, handling assembly 112, code reader device 114, and user interface 116.

Scan assembly 110 includes one or a combination of lenses, optical filters, charge-coupled devices (CCD), other types of optical sensors, photosensitive films, light sources, mirrors, shutters, adjustable apertures, and other devices for capturing an image of the specimen according to communications from computer 118.

Handling assembly 112 includes one or a combination of devices, such as movable grippers, arms, and plates, which are configured to align the specimen with scan assembly 110. Devices within handling assembly 112 can be operated manually by the user and/or automatically according to communications from computer 118. Handling assembly 112 can be configured to hold one or more specimens, specimen carriers, or cassettes.

Code reader device 114 includes one or a combination of components, such as sensors and emitters, configured to read, detect, or sense a machine readable code associated with the specimen, specimen carrier, or cassette. Code reader device 114 is configured to provide the code to computer 118

User interface 116 includes one or a combination of a display screen which can be touch sensitive, keyboard, graphical pointing device (such as a mouse or track ball), and other devices that enable a person to provide information to computer 118.

In some embodiments, user interface 116 is a graphical user interface (GUI) that allows a person to interact with scan system 100 using images exclusively or using images and text in combination. The images can include, without limitation, graphical icons representative of specimen properties and protocols described below.

Computer 118 includes one or a combination of digital processors configured to carry out arithmetic or logical operations. Computer 118 includes one or more non-transitory computer readable storage media, such as flash memory, other non-volatile solid-state memory devices, magnetic disk storage, and optical disk storage. Computer 118 can include and be configured to run an operating system such as LINUX, UNIX, OS X, or WINDOWS. The operating system can include various software modules and drivers for performing general system tasks and facilitating communication with scan assembly 110, handling assembly 112, code reader device 114, and user interface 116. The non-transitory computer readable media can include software modules with instructions for precisely controlling scan assembly 110, handling assembly 112, code reader device 114, and user interface 116. The non-transitory computer readable storage media can include scan conditions, protocols, rules, CSV files, and algorithms described below.

In some embodiments according to FIG. 2, specimen 130 is supported on carrier 132. Carrier 132 can be a transparent glass slide commonly used to mount biological specimens. Carrier 132 can be another type of support structure constructed according to the type and condition of the specimen. For example, carrier 132 can be a petri dish. Carrier 132 can be configured to be received and temporarily retained by handling assembly 112.

In some embodiments according to FIG. 3, carrier 132 can be configured to be received and temporarily retained within cassette 134. Cassette 134 is configured to carry multiple carriers 132 simultaneously and can be used to conveniently group similar or related specimens together and transport a large number of specimens to scan system 100 for image processing. Cassette 134 can be another type of container constructed according to the size and shape of specimen carrier 132. Cassette 134 can be configured to be received and temporarily retained by handling assembly 112.

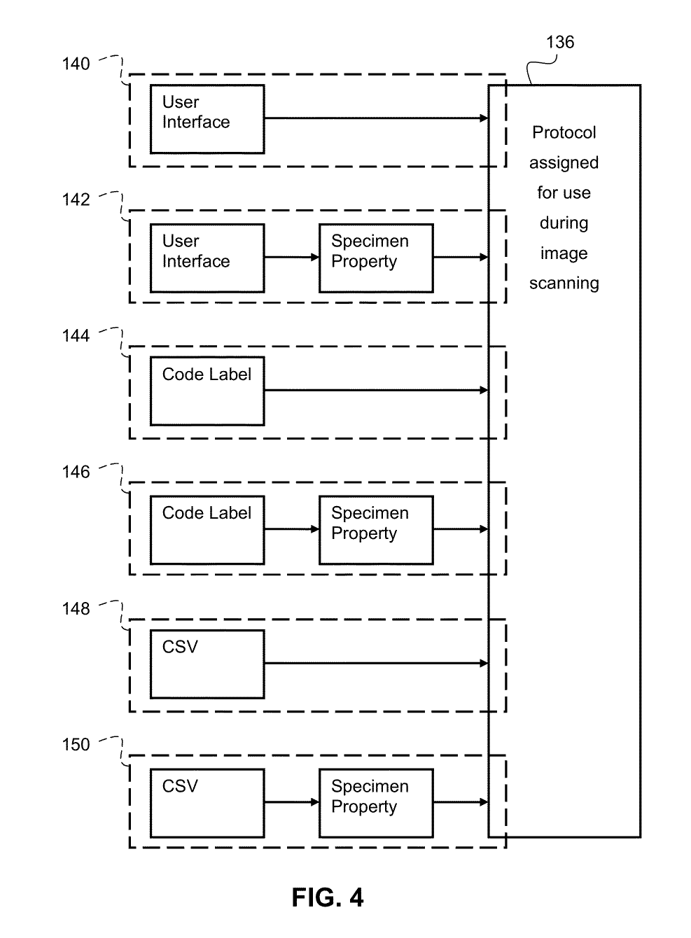

As shown in FIG. 4, a number of different processes can be implemented to assign protocol 136 for use with one or more image scans. Scan conditions are defined by protocol 136 and are used during the image scan(s).

In process block 140, user interface 116 is used to explicitly identify and assign protocol 136 for one or more image scans. Identification of protocol 136 is obtained directly from user interface 116. User interface 116 may show the user any number of protocol names, icons, or other identifier which correspond to protocols that are predefined and stored in computer 118. Each protocol corresponds to, defines, or contains one or more scan conditions.

For example, three protocol identifiers AAA, BBB, and CCC can be displayed by user interface 116. Scan conditions defined by protocol AAA may, for example, include a particular magnification factor, a particular exposure mode, and other scan condition values suitable for imaging stomach tissue. When the user wishes to scan stomach tissue, she interacts with user interface 116 to select protocol AAA, which causes protocol AAA (labeled 136 in FIG. 4) to be assigned to one or more stomach tissue specimens to be scanned.

In some embodiments, protocol 136 is assigned to one or more spaces in cassette 134 or in handling assembly 112 which contain stomach tissue specimens.

The protocols described above and below can define any value for various scan conditions. Each protocol has a unique identification, and it is to be understood that identifiers AAA, BBB, and CCC are exemplary and any other type of identifier may be used. Although each protocol is uniquely identified, it is possible for multiple protocols to specify the same scan condition values.

In process block 142 (FIG. 4), the user does not explicitly identify and assign protocol 136. Protocol 136 is inferred or determined indirectly from a specimen property. A specimen property includes one or more characteristics of the item to be scanned. Characteristics include without limitation a type of specimen and a type of staining that has already been applied to the specimen. The user interacts with user interface 116 to specify the specimen property. Next, computer 118 automatically matches the specified specimen property to a particular protocol (labeled 136 in FIG. 4). The matching procedure, also referred to as an inferring procedure, can be performed according to a rule, which is a type of algorithm. For example, the rule can dictate that protocol AAA be assigned for use if the user specifies the specimen type as stomach tissue.

In some embodiments, the rule encompasses multiple protocols. For example, the rule can dictate that protocol AAA be assigned for use when the specimen type is stomach tissue, that protocol BBB be assigned for use when the specimen type is skin tissue, and that protocol CCC be assigned for use when the specimen type is blood.

The rule described above and below can be a function of any number of characteristics of the specimen. The characteristics may depend on the nature of the specimen. A different protocol can be assigned by computer 118 with a change in any one of the characteristics. When reviewing biological specimens, for example, the rule can be a function of one or more characteristics such as the part of the anatomy from which the specimen was taken, type of dye used for staining the specimen, intended use or purpose of the image, and the type of attribute desired to be seen. When inspecting semiconductor wafers, for example, the rule can be a function of one or more characteristics such as fabrication method used to make the wafer, substrate material of the wafer, and intended end use of the wafer.

In some embodiments, the rule can include a look-up table or multivariable array having a plurality positions or records populated by one or more protocols, wherein each position or record corresponds to a different combination of characteristics of the specimen.

In some embodiments, any number of protocols (e.g., protocol AAA, protocol BBB, protocol CCC, and so on) can be predefined and stored in a non-transitory computer readable medium of computer 118. A person interacts with user interface 116 to specify a specimen type and staining type. During the scanning process, computer 118 determines that the specified specimen type and staining type corresponds to protocol BBB (labeled 136 in FIG. 4 for this example), computer 118 determines the scan conditions corresponding to protocol BBB, and then scan assembly 110 scans a specimen or group of specimens using the scan conditions corresponding to protocol BBB.

In process block 144 (FIG. 4), the protocol to be used is explicitly identified by code label 138 (FIGS. 2 and 3) which can be affixed to a specimen, specimen carrier 132, or cassette 134. Code label 138 includes a machine readable code that uniquely identifies a particular protocol. The code is obtained by code reader device 114 and is provided by code reader device 114 to computer 118. The identification contained in the machine readable code corresponds directly to a single protocol (labeled 136 in FIG. 4) among any number of protocols predefined and stored in computer 118. Computer 118 assigns protocol 136 to the specimen, specimen carrier 132, or cassette 134 on which code label 138 is attached.

Code label 138 can be in any computer readable format or medium. In some embodiments, code label 138 is a barcode, such as a two-dimensional matrix code or one-dimensional barcode.

For example, the machine readable code in code label 138 may translate to “0123-Stomach-HE-PRTCL:AAA”. Since the code includes the explicit protocol identifier “AAA”, the process defaults to using the identifier to determine which protocol to assign. Although the code identifies the specimen property (stomach tissue and H&E staining), the specimen property is not used to determine the protocol because the protocol identifier AAA is present in the code. During the scanning process, code reader device 114 reads code label 138 which identifies protocol AAA (labeled 136 in FIG. 4 for this example), computer 118 determines the scan conditions defined by protocol AAA, and then scan assembly 110 performs one or more image scans using the scan conditions defined by protocol AAA.

In process block 146 (FIG. 4), protocol 136 is not explicitly identified by code label 138 (FIGS. 2 and 3) which can be attached to a specimen, specimen carrier 132, or cassette 134. The machine readable code of code label 136 identifies the specimen property and does not directly identify the protocol to be used, so the protocol determination process reverts to using a rule based on the specimen property. Computer 118 matches the specimen property to a particular protocol (labeled 136 in FIG. 4). The matching can be performed according to a rule. The rule can be as previously described above for process block 142.

For example, the machine readable code of code label 138 can translate to “0123-Stomach-HE”. The code identifies the specimen property but does not explicitly identify the protocol to be used, so the process reverts to using a rule based on the specimen property. During the scanning process, code reader device 114 obtains the specimen property from reading code label 138, computer 118 obtains the specimen property from code reader device 114 and matches the specimen property to protocol AAA (labeled 136 in FIG. 4), computer 118 determines the scan conditions defined by protocol AAA, and then scan assembly 110 performs an image scan using the scan conditions defined by protocol AAA.

In process block 148 (FIG. 4), the protocol or protocols to be used for one or more specimens is/are explicitly identified by a CSV file. Computer 118 is configured to parse records contained in the CSV file. During a scanning process, computer 118 parses the records, computer 118 determines at least one record explicitly identifies a particular protocol (labeled 136 in FIG. 4), computer 118 determines the scan conditions defined by the protocol, and then scan assembly 110 performs one or more image scans using the scan conditions defined by the protocol.

In some embodiments, the CSV file contains only a single record that explicitly identifies a protocol.

In some embodiments, the CSV file contains multiple records that explicitly identify the same protocol to be used for multiple specimens.

In some embodiments, the CSV file contains multiple records that explicitly identify multiple protocols to be used for an equal number of specimens.

In process block 150 (FIG. 4), the protocol or protocols to be used for one or more specimens is/are not explicitly identified by a CSV file. The CSV file identifies the specimen property and does not directly identify the protocol to be used. During a scanning process, computer 118 parses the records contained in the CSV file, computer 118 determines at least one record identifies a specimen property and that none of the records explicitly identify a protocol, computer 118 matches the specimen property to a particular protocol (labeled 136 in FIG. 4), computer 118 determines the scan conditions defined by the protocol, and then scan assembly 110 performs one or more image scans using the scan conditions defined by the protocol. Computer 118 identifies protocol 136 from the specimen property according to a rule. The rule can be as previously described above for process block 142.

In some embodiments, the CSV file contains only a single record that explicitly identifies a specimen property.

In some embodiments, the CSV file contains multiple records that explicitly identify the same specimen property corresponding to multiple specimens.

In some embodiments, the CSV file contains multiple records that explicitly identify multiple specimen properties corresponding to an equal number of specimens.

In some embodiments according to process blocks 148 and 150, the CSV file is provided to computer 118 by the user through user interface 116, disk drive, flash drive, or a data port of computer 118.

In some embodiments according to process blocks 148 and 150, the CSV file is identified by any one or both of a CSV file name and CSV file path.

In some embodiments according to process blocks 148 and 150, the CSV file name is provided by the user to computer 118 or is obtained from code label 138, which enables computer 118 to locate the CSV file and parse the contents of the CSV file.

In some embodiments according to process blocks 148 and 150, the CSV file path is provided by the user to computer 118 or is obtained from code label 138, which enables computer 118 to locate the CSV file and parse the contents of the CSV file.

In some embodiments according to process blocks 148 and 150, a plurality of CSV files, CSV file names, and/or CSV file paths are stored in non-transitory computer readable storage media of computer 118 and are selectable by the user from user interface 116. Upon selection, computer 118 parses the contents of the corresponding CSV file.

Scan system 100 is configured to perform any one or a combination of processes 140, 142, 144, 146, 148, and 150 described above.

A method according to an embodiment of the present invention can include any one or a combination of processes 140, 142, 144, 146, 148, and 150 described above.

In any of the above embodiments, the scan conditions corresponding to protocol 136 can be implemented through the selection and use of specific hardware and/or software. For example, the required scan magnification and exposure (or other scan condition) can be implemented by computer 118 selecting the appropriate hardware combination from among a plurality of available lenses, filters, light sources, and/or optical sensors within scan assembly 110 and by adjusting any settings for the hardware. Alternatively or in combination with the selection and adjustment of hardware, the required magnification and exposure (or other scan condition) can be implemented through one or more software algorithms selected from among a plurality of available software algorithms stored within computer 118. For example, the selected software algorithms can be used by computer 118 to digitally modify or enhance the scan image.

In any of the above embodiments, scan system 100 is configured to generate an image in the form of any one or a combination of a computer readable digital image file, a photograph, a print, a transparent slide, and a film negative. Other image formats known in the art can be generated by scan system 100.

Embodiments of the present invention include a non-transitory computer readable medium having a stored computer program embodying instructions, which when executed by a computer, causes the computer to drive a scan assembly and optionally drive a handling assembly, a code reader device, and/or a user interface. The computer and the machines driven by the computer can be the same ones depicted in FIGS. 1 and 4 and described above, or they can be others. The computer readable medium comprises instructions for performing any one or a combination of the steps described above for processes 140, 142, 144, 146, 148, and 150, and optionally comprises any one or a combination of scan conditions, protocols, CSV files, rules, and algorithms described above.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. An image scan method comprising:
obtaining a protocol identifier; followed by
determining a plurality of scan conditions from the protocol identifier, the determining performed by a computer; and followed by
generating an image of a specimen according to the plurality of scan conditions.

2. The method of claim 1, wherein the obtaining of the protocol identifier includes the computer determining the protocol identifier from user interaction with a user interface in communication with the computer.

3. The method of claim 1, wherein the obtaining of the protocol identifier includes the computer inferring the protocol identifier from a specimen property of the specimen.

4. The method of claim 3, wherein the obtaining of the protocol identifier further includes the computer obtaining the specimen property from user interaction with a user interface before inferring the protocol identifier from the specimen property.

5. The method of claim 1, wherein the obtaining of the protocol identifier includes obtaining the protocol identifier from a machine readable code of a code label attached to the specimen, a carrier supporting the specimen, or a cassette containing the specimen.

6. The method of claim 1, wherein the obtaining of the protocol identifier includes the computer inferring the protocol identifier from a specimen property indicated in a machine readable code of a code label attached to the specimen, a carrier supporting the specimen, or a cassette containing the specimen.

7. The method of claim 6, wherein the obtaining of the protocol identifier further includes the computer obtaining the specimen property from a code reader device before inferring the protocol identifier from the specimen property.

8. The method of claim 1, wherein the obtaining of the protocol identifier includes the computer obtaining the protocol identifier from a CSV file.

9. The method of claim 8, wherein the obtaining of the protocol identifier further includes, before obtaining the protocol identifier from the CSV file, the computer receiving any one or both of a CSV file name and a CSV file path from a machine-readable code of a code label or from user interaction with a user interface.

10. The method of claim 1, wherein the obtaining of the protocol identifier includes the computer inferring the protocol identifier from a specimen property indicated in a CSV file.

11. The method of claim 10, wherein the obtaining of the protocol identifier further includes, before inferring the protocol identifier from the specimen property, the computer obtaining any one or both of a CSV file name and a CSV file path from a machine-readable code of a code label or from user interaction with a user interface.

12. An image scan system comprising:
a computer configured to determine a plurality of scan conditions from a protocol assigned to a specimen; and
a scan assembly in communication with the computer and configured to conduct an image scan of the specimen according the scan conditions determined by the computer.

13. The system of claim 12, further comprising a user interface in communication with the computer and configured to receive user input that identifies the protocol and assigns the protocol to the specimen, wherein the protocol is one in a plurality of protocols stored in the computer.

14. The system of claim 12, further comprising a user interface in communication with the computer and configured to receive user input that indicates a specimen property of the specimen, wherein the computer is configured to infer the protocol from the specimen property.

15. The system of claim 12, further comprising a code reader device in communication with the computer and configured to obtain an identifier of the protocol from a machine-readable code.

16. The system of claim 12, further comprising a code reader device in communication with the computer and configured to obtain, from a machine-readable code, a specimen property of the specimen, wherein the computer is configured to infer the protocol from the specimen property.

17. The system of claim 12, wherein the computer is configured to parse a record of a CSV file and to determine from the record an identifier of the protocol.

18. The system of claim 12, wherein the computer is configured to parse a record of a CSV file, determine from the record a specimen property of the specimen, and then infer the protocol from the specimen property.

19. A non-transitory computer readable medium having a stored computer program embodying instructions, which when executed by a computer, causes the computer to drive a scan assembly, the computer readable medium comprising:
instructions to obtain a protocol identifier;
instructions to determine a plurality of scan conditions from the protocol identifier; and
instructions to generate an image of a specimen according to the plurality of scan conditions.

20. The non-transitory computer readable medium of claim 19, further comprising instructions for determining the protocol identifier from any one or a combination of a machine readable code of a code label, user interaction with a user interface in communication with the computer, and a CSV file.

21. The non-transitory computer readable medium of claim 19, further comprising instructions for obtaining a specimen property of the specimen from any one or a combination of a machine readable code of a code label, user interaction with a user interface in communication with the computer, and a CSV file, and instructions for inferring the protocol identifier from a specimen property of the specimen.
